(19) United States
(12) Patent Application Publication
(10) Pub. No.: US 2025/0340704 A1
(43) Pub. Date: Nov. 6, 2025

(54) METHOD FOR PREPARING DUALLY-BONDED GRAPHENE OXIDE/NATURAL RUBBER COMPOSITE BASED ON HIGH-MOLECULAR-WEIGHT CATIONIC POLYMER

(71) Applicants: NORTH UNIVERSITY OF CHINA, Taiyuan (CN); SHANXI ZHONGBEI NEW MATERIAL TECHNOLOGY CO., LTD., Taiyuan (CN)

(72) Inventors: Yaqing LIU, Taiyuan (CN); Guizhe ZHAO, Taiyuan (CN); Bosong LI, Taiyuan (CN)

(21) Appl. No.: 19/267,835

(22) Filed: Jul. 14, 2025

(30) Foreign Application Priority Data
Dec. 17, 2024 (CN) 202411856325.X

(51) Int. Cl. C08J 3/22; C08K 3/04

(52) U.S. Cl. CPC C08J 3/22; C08K 3/042

(57) ABSTRACT

A dually-bonded graphene oxide/natural rubber composite is prepared as follows. A graphene oxide aqueous dispersion is added to a cationic polymer solution followed by ultrasonic treatment to obtain a first aqueous dispersion, which is added to a latex aqueous dispersion system of a natural rubber to obtain a mixture system. A flocculant is added to the mixture system for flocculation, followed by water washing, water removal, and drying to obtain a masterbatch. The masterbatch is subjected to internal mixing, and mixed with a vulcanization accelerator, an antioxidant, an anti-aging agent, an activator, a softener, and a reinforcing filler to obtain a first compound. The first compound is subjected to open milling, mixing with a vulcanizing agent and milling to obtain a second compound. The second compound is subjected to standing and vulcanization in a mold to obtain the dually-bonded graphene oxide/natural rubber composite.

### CROSS-REFERENCE TO RELATED APPLICATIONS

This application claims the benefit of priority from Chinese Patent Application No. 202411856325.X, filed on Dec. 17, 2024. The content of the aforementioned application, including any intervening amendments thereto, is incorporated herein by reference in its entirety.

### TECHNICAL FIELD

This application relates to graphene and its functional rubber composites, and more particularly to a method for preparing a dually-bonded graphene oxide/natural rubber based on a high-molecular-weight cationic polymer.

### BACKGROUND

Natural rubber (NR) latex is a renewable polymer material derived from rubber trees, containing a milky white colloid material cis-1,4-polyisoprene. A compounding agent in an aqueous dispersion form is added to a latex to obtain a compound latex, and then is gelatinized under the action of the coagulant to obtain a wet gel. The wet gel is filtered, dried, and vulcanized to obtain a NR product.

NR has excellent mechanical properties, tear resistance, and elasticity, and is widely used in fields such as automotive tires, wires, and cables. However, NR needs to be filled with fillers to achieve multiple functions, including high modulus, high tear resistance, and high thermal conductivity. In addition, in order to manufacture rubber composites with excellent comprehensive performance, nanoparticles with characteristics of small size and large surface area have become an ideal choice for reinforcing fillers of rubber matrices, which mainly are nano-carbon black, carbon nanotubes, nano-montmorillonite, and graphene.

Graphene oxide (GO) is a two-dimensional (2D) material with multiple oxygen-containing groups obtained by oxidizing graphite through physical and chemical means, and is an economic approach for mass production of graphene. Graphene and its derivatives have excellent mechanical strength, electrical conductivity, and thermal conductivity, and are widely used to enhance modified rubber, so that to prepare rubber composites with better mechanical strength, toughness, and thermal conductivity.

High-molecular-weight cationic polymers are linear biocompatible polymers with positive charges on their macromolecular chains, which are usually polymerized from monomers containing cationic groups such as amino and quaternary ammonium salts. Such positive charges enable the polymers to ionize cations in solutions and other systems. It is reported that the positive charges can be inserted into GO layers to reduce the number of GO layers. The high-molecular-weight cationic polymers have demonstrated extraordinary charm in material fields due to their series of unique properties of nearly zero vapor pressure, strong polarity, excellent thermal stability, and large electrochemical windows, and have already attracted extensive attention from researchers and related industries all over the world. In recent years, with the continuous development of material modification technologies, the high-molecular-weight cationic polymers have shone brightly in the field of filler modification by virtue of their own advantages, and have been widely used in the modification of fillers, which provides new ways to improve material performance.

Performance of rubber composites modified by nano-fillers is influenced by dispersion of the fillers and interfacial interaction between the fillers and rubber matrix. The interfacial interaction between the nano-fillers and polymer matrix is a main factor that leading to change of rubber properties, and has an important influence on the dispersion of nano-fillers. When only Van der Waals forces or hydrogen bonds exist, layers in GO tend to aggregate therebetween, which not only makes it difficult for GO to be uniformly dispersed in the NR matrix, but also leads to problems of weak bonding force between two phases, resulting in an unsatisfactory modification effect of NR. Therefore, it is urgent to develop a new rubber composite with a strong interfacial bonding force between GO and NR and a preparation thereof, which can not only improve stability and durability of rubber products, but also optimize other properties simultaneously.

### SUMMARY

In order to solve the problem that graphene oxide (GO) is hard to be dispersed in natural rubber (NR), this application provides a method for preparing a dually-bonding bonded graphene oxide/natural rubber based on a cationic polymer.

Technical solutions of this application are described as follows.

A method for preparing a dually-bonded graphene oxide/natural rubber based on a cationic polymer is provided, comprising:
(S1) dispersing a cationic polymer in water followed by ultrasonic treatment at a power S₁ for a preset period t₁ to obtain a cationic polymer solution, wherein a concentration of the cationic polymer solution is 0.5-5 mg/mL; and adding a graphene oxide aqueous dispersion with a concentration of 0.5-5 mg/mL to the cationic polymer solution followed by ultrasonic treatment at a power S₂ for a preset period t₂ and magnetic stirring at a temperature T₁ for a preset period t₃ to obtain a cationic polymer-modified graphene oxide aqueous dispersion, wherein a weight ratio of the cationic polymer to the graphene oxide in the graphene oxide aqueous dispersion is 3-9:10;
wherein a hydrophilic part of the cationic polymer is capable of generating cations in water by ionization to make a cationic polymer-modified graphene oxide particle in the cationic polymer-modified graphene oxide aqueous dispersion positively charged;
the cationic polymer is a double bond-containing cationic polymer with a molecular weight of 40,000-100,000; and
the double bond-containing cationic polymer is selected from the group consisting of poly(diallyl dimethyl ammonium chloride), polyethylenimine, polyacrylamide, poly(allylamine hydrochloride), and a combination thereof;
(S2) preparing a latex aqueous dispersion system of a natural rubber, wherein a natural rubber particle in the latex aqueous dispersion system is negatively charged due to adsorption of proteins and lipids on its surface; adding the cationic polymer-modified graphene oxide aqueous dispersion obtained in step (S1) to the latex aqueous dispersion system followed by mixing to obtain a mixture system, wherein a cationic polymer-modified graphene oxide particle in the cationic polymer-modified graphene oxide aqueous dispersion is combined with the natural rubber particle by bonding to form a combined particle; and adding a flocculant to the mixture system for flocculation to obtain a crude rubber, and subjecting the crude rubber to water washing, water removal, and drying to obtain a cationic polymer-modified graphene oxide/natural rubber masterbatch; and
(S3) subjecting the cationic polymer-modified graphene oxide/natural rubber masterbatch obtained in step (S2) to internal mixing, and sequentially adding rubber additives and a reinforcing filler to the cationic polymer-modified graphene oxide/natural rubber masterbatch followed by dispersion to obtain a first rubber compound, wherein the rubber additives include a vulcanization accelerator, an antioxidant, an anti-aging agent, an activator, and a softener; subjecting the first rubber compound to open milling followed by mixing with a vulcanizing agent and milling until there is no bubble, so as to obtain a second rubber compound; and subjecting the second rubber compound to standing for a preset period t₄, and transferring the second rubber compound to a mold for vulcanization to obtain the dually-bonded graphene oxide/natural rubber composite, wherein in the vulcanization process, a double bond of a hydrophobic part of the cationic polymer participates in a cross-linking reaction with a molecular chain of the natural rubber, so as to allow a chemical bonding between the cationic polymer-modified graphene oxide and the natural rubber.

In an embodiment, in step (S1), the power S₁ is 50-250 W; the preset period t₁ is 5-25 min; the power S₂ is 50-250 W; the preset period t₂ is 5-25 min; the temperature T₁ is 20-80° C.; and the preset period t₃ is 2-6 h.

In an embodiment, in step (S2), a concentration of the rubber latex aqueous dispersion system is 10-40 wt. %.

In an embodiment, in step (S3), an amount of the natural rubber in the cationic polymer-modified graphene oxide/natural rubber masterbatch is 100 phr; an amount of the cationic polymer-modified graphene oxide particle in the cationic polymer-modified graphene oxide/natural rubber masterbatch is 0.1-2 phr; an addition amount of the reinforcing filler is 30-90 phr; and an addition amount of the rubber additives is 10-20 phr.

In an embodiment, in step (S3), a weight ratio of the vulcanization accelerator to the antioxidant to the anti-aging agent to the activator to the softener to the vulcanizing agent is 2:2:2:5:2:2.

In an embodiment, in step (S3), the vulcanization accelerator is N-tert-butyl-2-benzothiazole sulfenamide, N-cyclohexyl-2-benzothiazole sulfonamide, or N-(oxydiethylene)-2-benzothiazole sulfenamide;
the antioxidant is N-(1,3-dimethylbutyl)-N′-phenyl-p-phenylenediamine, 4-phenyl aniline, or dilauryl thiodipropionate;
the anti-aging agent is 2,6-di-tert-butyl-4-methylphenol, poly(1,2-dihydro-2,2,4-trimethylquinoline), or 2-mercaptobenzimidazole;
the activator is zinc gluconate, zinc oxide, or magnesium oxide;
the softener is stearic acid, dibutyl titanate, or dioctyl adipate;
the reinforcing filler is carbon black, silicon dioxide, or clay; and
the vulcanizing agent is sulphur or sulfur monochloride.

In an embodiment, in step (S3), the internal mixing is performed at 105-120° C. for 9-15 min; the open milling is performed at 50-70° C. for 8-12 min; the preset period t₄ is 18-36 h; and the vulcanization is performed at 135-170° C. and 10-30 MPa for 3-25 min.

The present disclosure has the following beneficial effects.
(1) The present disclosure utilizes a simplified process that is easy to industrialize to positively modify graphene oxide with high-molecular-weight cationic polymers, while the surface of the NR particle in the latex aqueous dispersion system adsorbs the protein and the lipid to make the NR particle bring the negative charge. When the graphene oxide aqueous dispersion is added into the latex, the cationic polymer-modified graphene oxide particle bringing the positive charge and the NR particle bringing the negative charge form a bonding function, on the one hand, it is conductive to uniformly disperse the cationic polymer-modified graphene oxide particle into the natural rubber, on the other hand, it can enhance the interfacial interaction between the natural rubber and the modified graphene oxide.
(2) The hydrophobic end of the cationic polymer of the present disclosure is a long-chain structure with a double bond. In the vulcanization stage, the hydrophobic end of the cationic polymer can participate in the crosslinking reaction of the rubber molecular chain, enabling the cationic polymer-modified graphene oxide and the natural rubber to form a chemical bond connection, so as to limit the movement of the natural rubber molecular chain and make spatial distribution of the natural rubber molecular chain more compact. In such way, a crosslinking density of the natural rubber is increased and a crosslinking network becomes more complete, frictional heat generation between the filler and the NR and frictional heat generation between fillers decrease, and a graphene oxide-modified natural rubber composite material with high-strength, high-toughness, and low-heat-generation is obtained.
(3) The present disclosure uses modified graphene oxide aqueous dispersion and natural rubber latex as raw materials, and adopts aqueous phase synergistic sedimentation process, which is highly efficient, energy-saving, and environmentally friendly. Equipment involved in the present disclosure is conventional and has no strict requirements. Therefore, it is easy to be industrially produced and helps promote tire industry towards a direction that more environmentally friendly and high-performance.

### BRIEF DESCRIPTION OF THE DRAWINGS

Accompanying drawings herein are incorporated into the specification and form part of this specification, showing embodiments conforming to the present disclosure, and the present disclosure is with reference to the accompanying drawings together with the specification.

In order to illustrate the technical solutions of this application or the prior art more clearly, the accompanying drawings required in the description of embodiments or the prior art will be briefly introduced below. It is obvious that the following accompanying drawings only show some embodiments of this application, and for those of ordinary skill in the art, other relevant accompanying drawings can also be obtained according to these drawings without making creative effort.

FIG. 1 shows Zeta potentials of a aqueous dispersion of poly(diallyldimethylammonium chloride)-modified graphene oxide (PDDA@GO, and abbreviated as PGO⁺) and its modified NR latex (NRL/PDDA@GO, and abbreviated as NRL/PGO⁺) according to an embodiment of the present disclosure and a aqueous dispersion of GO and its modified NR latex (NRL/GO) according to Comparative example 1.

FIG. 2 shows an X-ray diffraction (XRD) spectrum of PDDA@GO (i.e. PGO⁺) prepared in Example 2 and GO in Comparative example 1.

FIG. 3 shows differential scanning calorimetry (DSC) curves of GO-modified NR composites prepared in Examples 1-3 and Comparative example 1.

FIG. 4 shows crosslinking densities of the GO-modified NR composites prepared in Examples 1-3 and Comparative example 1.

FIG. 5 shows bound rubber contents of the GO-modified NR composites prepared in Examples 1-3 and Comparative example 1.

Test methods of the above accompanying drawings are as follows.

Zeta potential test: a test solution with a concentration of 0.25 mg/mL is prepared, and a Zeta potential analyzer (Malvern, UK) is used to measure three times to obtain an average value.

XRD analysis: a Cu target material is used, a test sample is continuously scanned through a Kα ray (λ=0.1546 nm) at a speed of 5°/min within a range of 5-80°.

DSC test: the DSC test is performed at a nitrogen atmosphere with a heating speed of 5° C./min and a cooling speed of 5° C./min within a range of −80-25° C.

Crosslinking density test: 0.5 g of vulcanized rubber is marked as m₀, and is soaked in in an appropriate amount of toluene. Toluene is replaced every 24 h. After 72 h, a swollen substance is taken out and placed on a filter paper. After removal of the toluene on a surface of the swollen substance, the swollen substance is weighted and marked as m₁, and then is dried at 50° C. to a constant weight and is marked as m₂. The crosslinking density is calculated through formulas as follows:

$$Vr = \frac{{m}_{0} \times ∅ \times ( 1 - α ) / {ρ}_{r}}{{m}_{0} \times ( 1 - α ) / + ( m 1 - {m}_{2} ) / {ρ}_{s}} ;$$

where Vᵣ represents a volume fraction of rubber in the swollen substance; ϕ represents a weight fraction of the rubber in the test sample; a represents a loss rate of the test sample during the swelling process; ρᵣ represents a density of a rubber composite; and ρₛ represents a density of toluene; and

the crosslinking density is calculated through a Flory-Rehner formula as follows:

$$Ve = - \frac{ln ( 1 - {V}_{r} ) + Vr + χ {V}_{r}^{2}}{{V}_{s} ( {V}_{r}^{\frac{1}{3}} - {V}_{r} / 2 )} ;$$

where Ve represents the crosslinking density of the rubber; Vₛ represents a molar volume of toluene; and χ represents a solvent effect parameter between the rubber and toluene.

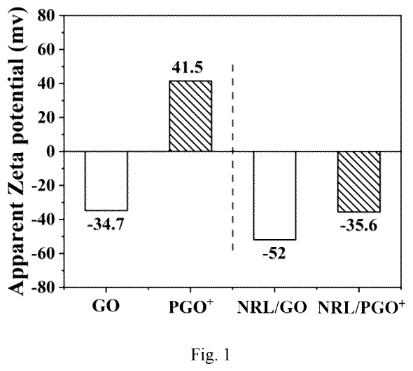

Bound rubber content test: a differential scanning calorimeter is used to test the bound rubber content at a temperature of −80 to 25° C. with a heating rate of 5° C./min, and the bound rubber content is calculated through a formula as follows:

$$\begin{matrix}Δ {C}_{pn} = Δ {C}_{p} / ( 1 - w ) ; and \\ {χ}_{im} = ( Δ {C}_{p 0} - Δ {C}_{pn} ) / Δ {C}_{p 0}\end{matrix}$$

where ΔCₚ and ΔCₚ₀ represent the heat capacity jump of filled rubber composite and heat capacity jump of the unfilled rubber at glass transition temperature, respectively; w represents the filler weight fraction in rubber composite; ΔCₚₙ represents the heat capacity jump normalized to the rubber weight fraction; and χᵢₘ represents the weight fraction of constrained rubber layer, namely, the bound rubber content. Referring to FIG. 1, GO aqueous dispersion brings a negative charge, and GO brings a positive charge (i.e., PGO⁺) is obtained through modification by the cationic polymer PDDA. In addition, compared with the GO-modified NR latex, a potential of PGO⁺-modified NR latex largens, that's because PGO⁺ bring the positive charge and the natural rubber particle in the latex bring the negative charge form bonding function, so that the potential of PGO⁺-modified NR latex largens.

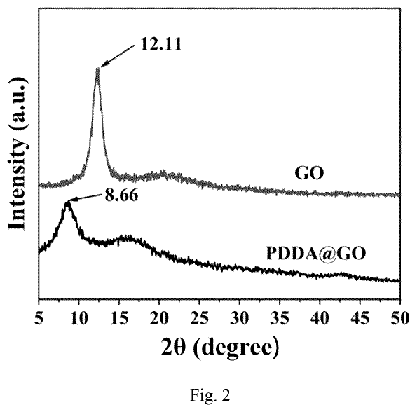

Referring to FIG. 2, a (001) diffraction peak of pure GO at 2θ=12.11° shifts leftwise to 8.66° in a PGO⁺ spectrogram. Calculation is performed according to Bragg equation, an interlayer spacing of GO is 0.74 nm, and an interlayer spacing of PGO⁺ is 1.03 nm, showing that the interlayer spacing significantly increases and GO is modified successfully.

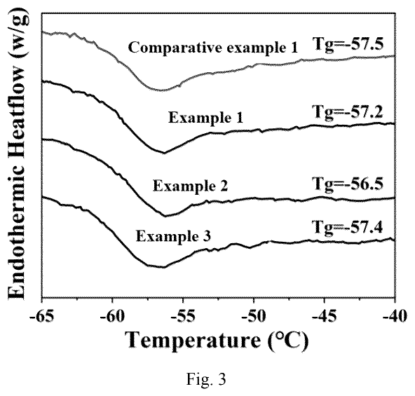

DSC curves can be used to determine interaction between NR matrix and a GO-modified filler, because the presence of filler usually leads to a change in glass transition temperature of the rubber matrix. Referring to FIG. 3, compared with Comparative example 1, the NR composites prepared in Examples 1-3 have increased glass transition temperatures. The reason is described as follow: a hydrophilic end, that is, a quaternary ammonium cation, of PDDA makes the modified GO particle bring the positive charge, while a protein and a lipid adsorbed on a surface of a NR particle make it bring the negative charge. When the graphene oxide aqueous dispersion is added into the natural rubber latex, the cationic polymer-modified graphene oxide particle bringing the positive charge and the natural rubber particle bringing the negative charge form a bonding function, on the one hand, it is conductive to uniformly disperse the cationic polymer-modified graphene oxide particle into the natural rubber, on the other hand, it can enhance the interfacial interaction between the natural rubber matrix and the modified graphene.

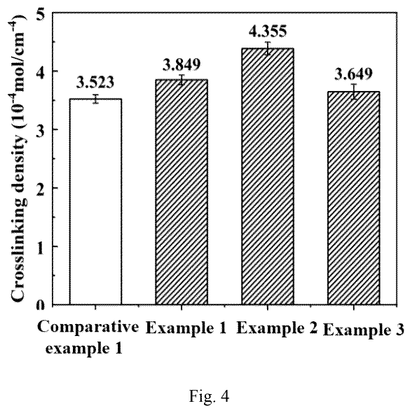

FIG. 4 shows crosslinking densities of the GO-modified NR composites. Compared with Comparative example 1, natural rubber vulcanized rubber prepared in Examples 1-3 have increased crosslinking densities. With the increase of the content of the cationic polymer, the crosslink density increases and the crosslink network becomes more complete. The reason is described as follow: the molecular structure of PDDA itself can promote chemical crosslinking to a certain extent. The hydrophobic end of PDDA is a long-chain structure with double bonds. During the vulcanization process, the hydrophobic end of PDDA can participate in crosslinking reaction of NR molecular chains, forming chemical bond connections between PDDA-modified GO and the NR matrix, thereby restricting the movement of NR molecular chains and making the spatial distribution of NR molecular chains more compact. In such way, a crosslinking density of the natural rubber vulcanized rubber is increased and a crosslinking network becomes more complete, frictional heat generation between the filler and the matrix and frictional heat generation between fillers decreases, and a graphene-modified natural rubber composite with high-strength, high-toughness, and low-heat-generation performance is obtained.

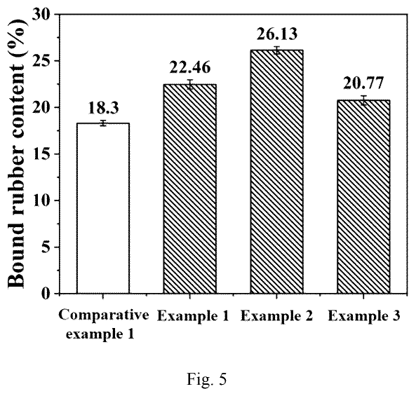

The formation of the crosslinking network structure largely depends on the bound rubber content, and the bound rubber content depends on the interaction between the matrix and the filler in the composite rubber. FIG. 5 shows the bound rubber contents of GO-modified natural rubber materials. Compared with Comparative example 1, natural rubber vulcanized rubber prepared in Examples 1-3 have increased bound rubber contents. With the increase of the content of the cationic polymer, the bound rubber content increases. The reason is described as follow: the PGO⁺ bringing the positive charge and the natural rubber particle bringing the negative charge in the NR latex form bonding function, and the dual-bond long-chain structure of the hydrophobic end of PDDA participates in the NR crosslinking reaction, so that chemical bond connection between PDDA-modified GO and NR matrix will double enhance the interfacial bonding force between the NR matrix and the GO.

### DETAILED DESCRIPTION OF EMBODIMENTS

To make the above object, features, and advantages of the present disclosure more clearly, the present disclosure will be further described below. It should be noted that the embodiments and features of the embodiments of the present disclosure can be combined with each other without conflicts.

Many specific details herein are described for complete understanding. However, the present disclosure can be implemented in other ways different from those described herein. It is obvious that described herein are only some embodiments of the present disclosure, rather than all embodiments.

The present disclosure provides a method for preparing a dual-bonding graphene oxide/natural rubber composite including the following steps.
(S1) A cationic polymer is dispersed in water, followed by ultrasonic treatment at a power S₁ for a preset period t₁ to obtain a cationic polymer solution with a concentration of 0.5-5 mg/mL. A graphene oxide aqueous dispersion with a concentration of 0.5-5 mg/mL is added to the cationic polymer solution, followed by ultrasonic treatment at a power S₂ for a preset period t₂ and magnetic stirring at a temperature T₁ for a preset period t₃ to obtain a cationic polymer-modified graphene oxide aqueous dispersion with a weight ratio of the cationic polymer to the graphene oxide of 3-9:10.

In step (S1), a hydrophilic part of the cationic polymer is capable of generating cations in water by ionization to make a cationic polymer-modified graphene oxide particle in the cationic polymer-modified graphene oxide aqueous dispersion positively charged. The cationic polymer is a double bond-containing cationic polymer with a molecular weight of 40,000-100,000. The double bond-containing cationic polymer is selected from the group consisting of poly(diallyl dimethyl ammonium chloride), polyethylenimine, polyacrylamide, poly(allylamine hydrochloride), and a combination thereof.
(S2) A latex aqueous dispersion system of a natural rubber is prepared, where a natural rubber particle in the latex aqueous dispersion system is negatively charged due to adsorption of proteins and lipids on its surface. The cationic polymer-modified graphene oxide aqueous dispersion obtained in step (S1) is added to the latex aqueous dispersion system and mixed to obtain a mixture system, where in this process, a cationic polymer-modified graphene oxide particle in the cationic polymer-modified graphene oxide aqueous dispersion is combined with the natural rubber particle by bonding to form a combined particle. A flocculant is added to the mixture system for flocculation to obtain a crude rubber, and the crude rubber is subjected to water washing, water removal, and drying to obtain a cationic polymer-modified graphene oxide/natural rubber masterbatch.
(S3) The cationic polymer-modified graphene oxide/natural rubber masterbatch obtained in step (S2) is subjected to internal mixing, and rubber additives and a reinforcing filler are sequentially added to the cationic polymer-modified graphene oxide/natural rubber masterbatch followed by dispersion to obtain a first rubber compound, where the rubber additives include a vulcanization accelerator, an antioxidant, an anti-aging agent, an activator, and a softener. The first rubber compound is subjected to open milling, followed by mixing with a vulcanizing agent and thin-passing until there is no bubble, so as to obtain a second rubber compound. The second rubber compound is subjected to standing for a preset period t₄, and the second rubber compound is transferred to a mold for vulcanization to obtain the dually-bonded graphene oxide/natural rubber composite, where in the vulcanization process, a double bond of a hydrophobic part of the cationic polymer participates in a cross-linking reaction of a molecular chain of the natural rubber, so as to allow a chemical bonding between the cationic polymer-modified graphene oxide and the natural rubber.

In an embodiment, in step (S1), the power S₁ is 50-250 W; the preset period t₁ is 5-25 min; the power S₂ is 50-250 W; the preset period t₂ is 5-25 min; the temperature T₁ is 20-80° C.; and the preset period t₃ is 2-6 h.

In an embodiment, in step (S2), a concentration of the latex aqueous dispersion system is 10-40 wt. %.

In an embodiment, in step (S3), an amount of the natural rubber in the cationic polymer-modified graphene oxide/natural rubber masterbatch is 100 phr (parts per hundred of rubber); an amount of the cationic polymer-modified graphene oxide particle in the cationic polymer-modified graphene oxide/natural rubber masterbatch is 0.1-2 phr; an addition amount of the reinforcing filler is 30-90 phr; and an addition amount of the rubber additives is 10-20 phr.

In an embodiment, in step (S3), a weight ratio of the vulcanization accelerator to the antioxidant to the anti-aging agent to the activator to the softener to the vulcanizing agent is 2:2:2:5:2:2.

In an embodiment, in step (S3), the vulcanization accelerator is N-tert-butyl-2-benzothiazole sulfenamide, N-cyclohexyl-2-benzothiazole sulfonamide, or N-(oxydiethylene)-2-benzothiazole sulfenamide. The antioxidant is N-(1,3-dimethylbutyl)-N′-phenyl-p-phenylenediamine, 4-phenyl aniline, or dilauryl thiodipropionate. The anti-aging agent is 2,6-di-tert-butyl-4-methylphenol, poly(1,2-dihydro-2,2,4-trimethylquinoline), or 2-mercaptobenzimidazole. The activator is zinc gluconate, zinc oxide, or magnesium oxide. The softener is stearic acid, dibutyl titanate, or dioctyl adipate. The reinforcing filler is carbon black, silicon dioxide, or clay. The vulcanizing agent is sulphur or sulfur monochloride.

In an embodiment, in step (S3), the internal mixing is performed at 105-120° C. for 9-15 min; the open milling is performed at 50-70° C. for 8-12 min; the preset period t₄ is 18-36 h; and the vulcanization is performed at 135-170° C. and 10-30 MPa for 3-25 min.

Specific embodiments of the present disclosure are described in detail as follows.

### Example 1

A method for preparing a dual-bonding graphene oxide/natural rubber composite included the following steps.
(S1) 0.25 phr of PDDA was dispersed in 125 mL of water, followed by ultrasonic treatment at a power of 200 W for 10 min to obtain a PDDA solution. 2 mg/mL of GO aqueous dispersion was added to the PDDA solution followed by ultrasonic treatment at a power of 200 W for 15 min, where a weight ratio of PDDA to GO was 5:10. Magnetic stirring was performed at 25° C. for 2 h to obtain a PDDA-modified GO aqueous dispersion.
(S2) NR latex was dispersed in a certain amount of deionized water to obtain a 30 wt. % latex aqueous dispersion system of NR. The PDDA-modified GO aqueous dispersion obtained in step (S1) was added to the 30 wt. % latex aqueous dispersion system of NR followed by mixing to obtain a mixture system, where in this process, a hydrophilic end of PDDA in the PDDA-modified GO aqueous dispersion ionized to generate a quaternary ammonium cation to make a PDDA-modified GO particle be positively charged, and a surface of a NR particle in the latex aqueous dispersion system adsorbed a protein and a lipid to make the NR particle be negatively charged. Therefore, when the PDDA-modified GO aqueous dispersion was added into the latex aqueous dispersion system, the PDDA-modified GO particle was combined with the natural rubber particle by bonding to form a combined particle. A flocculant of a 10 wt. % CaCl₂ solution was added to the mixture system for flocculation to obtain a crude rubber, and the crude rubber was subjected to water washing, water removal, and drying at 60° C. to obtain a PDDA-modified GO/NR masterbatch.
(S3) The PDDA-modified GO/NR masterbatch obtained in step (S2) with 100 phr of NR was subjected to internal mixing at 110° C. in an internal mixer for 12 min, where during this process, 2 phr of a vulcanization accelerator N-Cyclohexyl-2-benzothiazolesulfenamide, 2 phr of an antioxidant N-(1,3-dimethylbutyl)-N′-phenyl-p-phenylenediamine, 2 phr of an anti-aging agent 2,6-di-tert-butyl-4-methylphenol, 5 phr of an activator zinc oxide, 2 phr of a softener stearic acid, and 35 phr of a reinforcing filler carbon black were added in three separate batches, and a rubber compound was obtained. The rubber compound was cooled to a room temperature, and then was transferred to a mixing mill for open milling at 60° C. for 10 min, where during this process, 2 phr of sulphur was added, and after uniform mixing, thin-passing was performed until the rubber compound had no bubble to obtain a rubber compound film. The rubber compound film was placed for 24 h, followed by placing in a mold for vulcanization at 150° C. at 15 MPa for a certain period of time, where when the placing was performed for 6 min, a degree of crosslinking of the rubber compound film was tested through a rubber process analyzer (RPA), and the degree of crosslinking of the rubber compound film was torque cure 90% (t_{c90}). In the vulcanization process, a double bond of a hydrophobic part of PDDA participated in cross-linking reaction of a NR molecular chain, so that the PDDA-modified GO formed a chemical bond connection with the natural rubber to obtain the dual-bonding graphene oxide/natural rubber composite.

### Example 2

This example was the same as Example 1, except that in step (S1), an amount of PDDA was 0.35 phr, that was, a weight ratio of PDDA to GO was 7:10.

### Example 3

This example was the same as Example 1, except that in step (S1), an amount of PDDA was 0.45 phr, that was, a weight ratio of PDDA to GO was 9:10.

Formulas of Examples 1-3 were shown in Table 1, and performance test results were shown in Table 2.

### Comparative Example 1

A GO-modified NR composite was prepared through the following steps.
(S1) Deionized water was dispersed into GO to obtain a 2 mg/mL GO aqueous dispersion.
(S2) This step was the same as that in Examples 1-3, except that the PDDA-modified GO in step (S2) in Examples 1-3 was replaced with GO of the same weight.
(S3) This step was the same as that in Examples 1-3. A formula of the Comparative example 1 was shown in Table 1, and performance test results were shown in Table 2.

Performance tests were conducted on the natural rubber composites obtained in Examples 1-3 and Comparative example 1. Tensile property was tested based on an executive standard of ISO 37-2005 at a tensile rate of 500 mm/min. Tear resistance was tested based on an executive standard of GB/T 529-2008. Hardness was tested based on an executive standard of GB/T 531.1-2008. Heat generation performance was tested based on an executive standard of GB/T 1687.1-2016. Wear resistance was tested based on an executive standard of GB/T 9867-2008.

TABLE 1
Formulas of Examples 1-3 and Comparative example 1

| | Example | Example | Example | Comparative |
|---|---|---|---|---|
| Item | 1 | 2 | 3 | example 1 |
| NR (phr) | 100 | 100 | 100 | 100 |
| GO (phr) | 0.5 | 0.5 | 0.5 | 0.5 |
| PDDA (phr) | 0.25 | 0.35 | 0.45 | — |
| N-cyclohexyl-2- | 2 | 2 | 2 | 2 |
| benzothiazole- | | | | |
| sulfenamide (phr) | | | | |
| N-(1-methylpentyl)-N′- | 2 | 2 | 2 | 2 |
| phenyl-p- | | | | |
| phenylenediamine | | | | |
| (phr) | | | | |
| 2,6-di-tert-butyl-4- | 2 | 2 | 2 | 2 |
| methylphenol (phr) | | | | |
| Zinc oxide (phr) | 5 | 5 | 5 | 5 |
| Stearic acid (phr) | 2 | 2 | 2 | 2 |
| Carbon black (phr) | 35 | 35 | 35 | 35 |
| Sulphur (phr) | 2 | 2 | 2 | 2 |

TABLE 2
Performance test results of natural rubber composites
in Examples 1-3 and Comparative example 1

| | Example | Example | Example | Comparative |
|---|---|---|---|---|
| | 1 | 2 | 3 | example 1 |
| Tensile strength (MPa) | 29.12 | 30.04 | 28.67 | 26.40 |
| Tearing strength | 61.56 | 63.90 | 58.21 | 53.72 |
| (N/mm) | | | | |
| Hardness (HA) | 60.5 | 61 | 60 | 59.5 |
| Wear volume (mm³) | 103.9 | 101.1 | 106.9 | 118.2 |
| Dynamic compression | 10.1 | 9.9 | 10.3 | 11.7 |
| heat generation (° C.) | | | | |

Referring to Table 2, compared with the GO-modified NR composite prepared in Comparative example 1, the dual-bonding graphene oxide/natural rubber composites of the present disclosure had improved tensile strength, tearing strength, dynamic compression heat generation, and wear volume, achieving high-strength, high-toughness, and low-heat-generation performance.

Described above are specific embodiments of the present disclosure, which makes those skilled in the art understand or realize the present disclosure. Although detailed description has been made with reference to the above embodiments, it should be understood by those skilled in the art that modifications and equivalent replacements can still be made to some or all of the technical features recited in the above embodiments. Such modifications and replacements made without departing from the scope of the present disclosure shall fall within the scope of this application defined by the appended claims.

What is claimed is:

1. A method for preparing a dually-bonded graphene oxide/natural rubber composite, comprising:
(S1) dispersing a cationic polymer in water followed by ultrasonic treatment at a power S₁ for a preset period t₁ to obtain a cationic polymer solution, wherein a concentration of the cationic polymer solution is 0.5-5 mg/mL; and adding a graphene oxide aqueous dispersion with a concentration of 0.5-5 mg/mL to the cationic polymer solution followed by ultrasonic treatment at a power S₂ for a preset period t₂ and magnetic stirring at a temperature T₁ for a preset period t₃ to obtain a cationic polymer-modified graphene oxide aqueous dispersion, wherein a weight ratio of the cationic polymer to graphene oxide in the graphene oxide aqueous dispersion is 3-9:10; wherein a hydrophilic part of the cationic polymer is capable of generating cations in water by ionization to make a cationic polymer-modified graphene oxide particle in the cationic polymer-modified graphene oxide aqueous dispersion positively charged;
the cationic polymer is a double bond-containing cationic polymer with a molecular weight of 40,000-100,000; and
the double bond-containing cationic polymer is selected from the group consisting of poly(diallyl dimethyl ammonium chloride), polyethylenimine, polyacrylamide, poly(allylamine hydrochloride), and a combination thereof;
(S2) preparing a latex aqueous dispersion system of a natural rubber, wherein a natural rubber particle in the latex aqueous dispersion system is negatively charged due to adsorption of proteins and lipids on its surface; adding the cationic polymer-modified graphene oxide aqueous dispersion obtained in step (S1) to the latex aqueous dispersion system followed by mixing to obtain a mixture system, wherein a cationic polymer-modified graphene oxide particle in the cationic polymer-modified graphene oxide aqueous dispersion is combined with the natural rubber particle by bonding to form a combined particle; and adding a flocculant to the mixture system for flocculation to obtain a crude rubber, and subjecting the crude rubber to water washing, water removal, and drying to obtain a cationic polymer-modified graphene oxide/natural rubber masterbatch; and
(S3) subjecting the cationic polymer-modified graphene oxide/natural rubber masterbatch obtained in step (S2) to internal mixing, and sequentially adding rubber additives and a reinforcing filler to the cationic polymer-modified graphene oxide/natural rubber masterbatch followed by dispersion to obtain a first rubber compound, wherein the rubber additives comprise a vulcanization accelerator, an antioxidant, an anti-aging agent, an activator, and a softener; subjecting the first rubber compound to open milling followed by mixing with a vulcanizing agent and milling until there is no bubble, so as to obtain a second rubber compound; and subjecting the second rubber compound to standing for a preset period t₄, and transferring the second rubber compound to a mold for vulcanization to obtain the dually-bonded graphene oxide/natural rubber composite, wherein in the vulcanization process, a double bond of a hydrophobic part of the cationic polymer participates in a cross-linking reaction with a molecular chain of the natural rubber, so as to allow a chemical bonding between the cationic polymer-modified graphene oxide and the natural rubber.

2. The method of claim 1, wherein in step (S1), the power S₁ is 50-250 W; the preset period t₁ is 5-25 min; the power S₂ is 50-250 W; the preset period t₂ is 5-25 min; the temperature T₁ is 20-80° C.; and the preset period t₃ is 2-6 h.

3. The method of claim 1, wherein in step (S2), a concentration of the latex aqueous dispersion system is 10-40 wt. %.

4. The method of claim 1, wherein in step (S3), an amount of the natural rubber in the cationic polymer-modified graphene oxide/natural rubber masterbatch is 100 phr; an amount of the cationic polymer-modified graphene oxide particle in the cationic polymer-modified graphene oxide/natural rubber masterbatch is 0.1-2 phr; an addition amount of the reinforcing filler is 30-90 phr; and an addition amount of the rubber additives is 10-20 phr.

5. The method of claim 1, wherein in step (S3), a weight ratio of the vulcanization accelerator to the antioxidant to the anti-aging agent to the activator to the softener to the vulcanizing agent is 2:2:2:5:2:2.

6. The method of claim 1, wherein in step (S3), the vulcanization accelerator is N-tert-butyl-2-benzothiazole sulfenamide, N-cyclohexyl-2-benzothiazole sulfonamide, or N-(oxydiethylene)-2-benzothiazole sulfenamide;
the antioxidant is N-(1,3-dimethylbutyl)-N′-phenyl-p-phenylenediamine, 4-phenyl aniline, or dilauryl thiodipropionate;
the anti-aging agent is 2,6-di-tert-butyl-4-methylphenol, poly(1,2-dihydro-2,2,4-trimethylquinoline), or 2-mercaptobenzimidazole;
the activator is zinc gluconate, zinc oxide, or magnesium oxide;
the softener is stearic acid, dibutyl titanate, or dioctyl adipate;
the reinforcing filler is carbon black, silicon dioxide, or clay; and
the vulcanizing agent is sulphur or sulfur monochloride.

7. The method of claim 1, wherein in step (S3), the internal mixing is performed at 105-120° C. for 9-15 min; the open milling is performed at 50-70° C. for 8-12 min; the preset period t₄ is 18-36 h; and the vulcanization is performed at 135-170° C. and 10-30 MPa for 3-25 min.
